(19) United States
(12) Patent Application Publication
(10) Pub. No.: US 2016/0242021 A1
(43) Pub. Date: Aug. 18, 2016

(54) METHOD AND DEVICE FOR DISCOVERY DETECTION IN DEVICE-TO-DEVICE COMMUNICATION

(71) Applicant: Alcatel Lucent, Boulogne-Billancourt (FR)

(72) Inventors: Dong Li, Shanghai (CN); Yong Liu, Shanghai (CN)

(73) Assignee: Alcatel Lucent, Boulogne Billancourt (FR)

(21) Appl. No.: 15/024,149

(22) PCT Filed: Sep. 24, 2014
(86) PCT No.: PCT/IB2014/002335

§ 371 Date: Mar. 23, 2016

(30) Foreign Application Priority Data
Sep. 27, 2013 (CN) 201310454583.0

(51) Int. Cl. H04W 8/00; H04W 48/16

(52) U.S. Cl. CPC H04W 8/005; H04W 48/16; H04W 92/18

(57) ABSTRACT

Embodiments of the present invention provide methods and devices for discovery detection in device-to-device communication. A method at a first device side comprises constructing a discovery packet on each of a predetermined number of discovery cycles, wherein each discovery packet includes identical discovery information, the predetermined number being greater than 1. The method further comprises transmitting the discovery packet to at least one second device on each of the predetermined number of discovery cycles using a logically identical discovery channel. A method at a second device side comprises: receiving a discovery packet transmitted by a first device on each of a predetermined number of discovery cycles using a logically identical discovery channel; soft merging the predetermined number of discovery packets. The method further comprising detecting the discovery information in the soft merged discovery packet. Through the embodiments of the present invention, diversity gain of the soft merged discovery packet is enhanced and then detection performance regarding the discovery information is improved.

### FIELD OF THE INVENTION

Embodiments of the present invention generally relate to the communication field, and more specifically, to methods and devices for discovery detection in device-to-device (D2D) communication.

### BACKGROUND OF THE INVENTION

In D2D communication, in order to establish the D2D communication between multiple devices, mutual discovery between devices is required. In existing communication standards, channel resources allocated for mutual discovery between devices are usually periodic channel resources and occupy relative fewer time-frequency resources. For example, each discovery channel usually occupies one RB (resource block) and 1 ms of time.

According to an existing technical solution, when performing discovery detection, a first device constructs a discovery packet on each discovery cycle, and transmits discovery information to a second device using the allocated discovery channel on each discovery cycle; wherein the discovery packet includes the discovery information, and the discovery information includes a device ID and a service ID, etc. The discovery information included in the discovery packet may be changed between multiple discovery cycles, and the allocated discovery channel may also be changed. A second device receives the discovery packet transmitted by the first device on each discovery cycle using the allocated discovery channel and detects the discovery information in each discovery packet, respectively. If the discovery information is successfully detected, D2D communication may be established with the first device.

However, the existing technical solution has certain drawbacks. Since the channel resources occupied by each discovery channel are relatively fewer, diversity gain of the discovery packet transmitted on such discovery channel is very small, such that detection performance of the second device regarding the discovery information in the data packet is relatively poor.

### SUMMARY OF THE INVENTION

In view of the technical problems existing in the prior art, various embodiments of the present invention provide methods and devices for discovery detection in device-to-device communication.

According to a first aspect of the present invention, there is provided a method for discovery detection in device-to-device communication. The method comprises: constructing a discovery packet on each of a predetermined number of discovery cycles, wherein each discovery packet includes identical discovery information, the predetermined number being greater than 1. The method further comprises transmitting the discovery packet to at least one second device using a logically identical discovery channel on each of the predetermined number of discovery cycles.

According to an alternative embodiment of the present invention, the method further comprises: encoding the discovery information into at least one coding version.

According to an alternative embodiment of the present invention, wherein the coding version of the discovery information included in each discovery packet is the same.

According to an alternative embodiment of the present invention, wherein the coding versions of the discovery information included in at least two of the predetermined number of discovery packets are different.

According to a second aspect of the present invention, there is provided a method for discovery detection in device-to-device communication. The method comprises: receiving a discovery packet transmitted by a first device using a logically identical discovery channel on each of a predetermined number of discovery cycles, wherein each discovery packet includes identical discovery information, and the predetermined number being greater than 1; soft merging the predetermined number of discovery packets. The method further comprises detecting the discovery information in the soft merged discovery packet.

According to alternative embodiment of the present invention, wherein soft merging the predetermined number of discovery packets comprises: soft merging the predetermined number of discovery packets according to a coding version of the discovery information included in each discovery packet.

According to alternative embodiment of the present invention, wherein soft merging the predetermined number of discovery packets according to a coding version of the discovery information included in each discovery packet comprises: superimposing soft demodulated outputs corresponding to the predetermined number of discovery packets in a soft bit circular buffer when the coding version of the discovery information included in each discovery packet is the same.

According to alternative embodiment of the present invention, wherein soft merging the predetermined number of discovery packets according to a coding version of the discovery information included in each discovery packet comprises: superimposing overlapped portions and combining non-overlapped portions between soft demodulated outputs corresponding to the predetermined number of discovery packets according to a coding version number of the discovery information included in each discovery packet in a soft bit circular buffer, when the coding versions of the discovery information included in at least two of the predetermined number of discovery packets are different.

According to alternative embodiment of the present invention, wherein when the same discovery information is included in each discovery packet received on each discovery cycle in a plurality of predetermined numbers of discovery cycles, the method further comprises: when the discovery information is detected in any of a plurality of merged discovery packets, determining that the discovery information is successfully detected.

According to a third aspect of the present invention, there is provided a device. The device comprises: a constructing module for constructing a discovery packet on each of a predetermined number of discovery cycles, wherein each discovery packet includes identical discovery information, the predetermined number being greater than 1. The device further comprises a transmitting module for transmitting the discovery packet to at least one second device using a logically identical discovery channel on each of the predetermined number of discovery cycles.

According to an alternative embodiment of the present invention, the device further comprises an encoding module for encoding the discovery information into at least one coding version.

According to an alternative embodiment of the present invention, wherein the coding version of the discovery information included in each discovery packet is the same.

According to an alternative embodiment of the present invention, wherein the coding versions of the discovery information included in at least two of the predetermined number of discovery packets are different.

According to a fourth aspect of the present invention, there is provided a device. The device comprises: a receiving module for receiving discovery packets transmitted by a first device using a logically identical discovery channel on each of a predetermined number of discovery cycles, wherein each discovery packet includes identical discovery information, the predetermined number being greater than 1; a soft combining module for soft merging the predetermined number of discovery packets; and a detecting module for detecting the discovery information in the soft merged discovery packet.

According to an alternative embodiment of the present invention, wherein the soft merging module is further for soft merging the predetermined number of discovery packets according to a coding version of the discovery information included in each discovery packet.

According to an alternative embodiment of the present invention, wherein the soft merging module is further for superimpose soft demodulated outputs corresponding to the predetermined number of discovery packets in a soft bit circular buffer when the coding version of the discovery information included in each discovery packet is the same.

According to an alternative embodiment of the present invention, wherein the soft merging module is further for superimposing overlapped portions and combining non-overlapped portions between soft demodulated outputs corresponding to the predetermined number of discovery packets according to a coding version number of the discovery information included in each discovery packet in a soft bit circular buffer, when the coding versions of the discovery information included in at least two of the predetermined number of discovery packets are different.

According to an alternative embodiment of the present invention, wherein when the same discovery information is included in each discovery packet received on each discovery cycle in a plurality of predetermined numbers of discovery cycles, the device further comprises: a determining module for determining that the discovery information is successfully detected when the discovery information is detected in any of a plurality of merged discovery packets.

According to a fifth aspect of the present invention, there is provided a system. The system comprises: a first device according to the above third aspect. The system further comprises: at least one second device according to the above fourth aspect.

By virtue of the methods and devices according to various aspects and embodiments of the present invention, the discovery packets transmitted by the first device using a logically identical discovery channel on each of a predetermined number of discovery cycles include the same discovery information, and the received predetermined number of discovery packets may be soft merged by the second device, which enhances diversity gain, coding gain, and power gain of the soft merged discovery packet, and then further enhances detection performance regarding the discovery information in the merged discovery packet.

### BRIEF DESCRIPTION OF THE ACCOMPANYING DRAWINGS

Other features, objectives, and aspects of various embodiments of the present disclosure will become more apparent through the following detailed description with reference to the following drawings. In the accompanying drawings, same or similar reference numerals represent the same or similar modules or method steps, wherein:

FIG. 1 shows a flow diagram of a method of discovery detection performed by a first device according to an embodiment of the present invention;

FIG. 2 shows a flow diagram of encoding discovery information into at least one coding version according to an embodiment of the present invention;

FIG. 3 shows a flow diagram of a method of discovery detection performed by a second device according to an embodiment of the present invention;

FIG. 4 shows an interaction diagram of methods of discovery detection performed by the first device and the second device according to an embodiment of the present invention;

FIG. 5 shows a comparison diagram of detection performances under different predetermined numbers according to an embodiment of the present invention;

FIG. 6 shows a comparison diagram of detection performances under different merging manners according to an embodiment of the present invention;

FIG. 7 shows a block diagram of a first device according to an embodiment of the present invention;

FIG. 8 shows a block diagram of a second device according to an embodiment of the present invention; and

FIG. 9 shows a block diagram of a system according to an embodiment of the present invention.

### DETAILED DESCRIPTION OF THE PREFERRED EMBODIMENTS

The principle and spirit of the present invention will be described hereinafter with reference to several exemplary embodiments as shown in the accompanying drawings. It should be understood that these embodiments are described only for purpose of enabling those skilled in the art to better understand the present invention, not intended to limit the scope of the present invention in any manner.

It may be understood that although exemplary embodiments of the present invention provide performing discovery detection in an application scenario of D2D communication, the methods provided by implementations of the present invention may also be applied to perform discovery detection in other application scenarios that require mutual discovery between devices.

In embodiments of the present invention, a first device acts as a transmitting end that transmits a discovery packet including discovery information to at least one second device, and a second device acts as a receiving end for receiving the discovery packet including discovery information that is transmitted by the first device and for detecting discovery information in the discovery packet. The first device and the second device may be devices such as a mobile phone, a tablet computer, a portable computer, a laptop computer, and the like. It should be understood that the first device and the second device may act as a transmitting end and a receiving end, respectively, and the device used as the transmitting end may transmit a discovery packet to multiple devices used as receiving ends, while the device used as the receiving end may receive discovery packets transmitted by multiple devices used as transmitting ends.

Various embodiments of the present invention will be described in detail hereinafter with reference to the accompanying drawings.

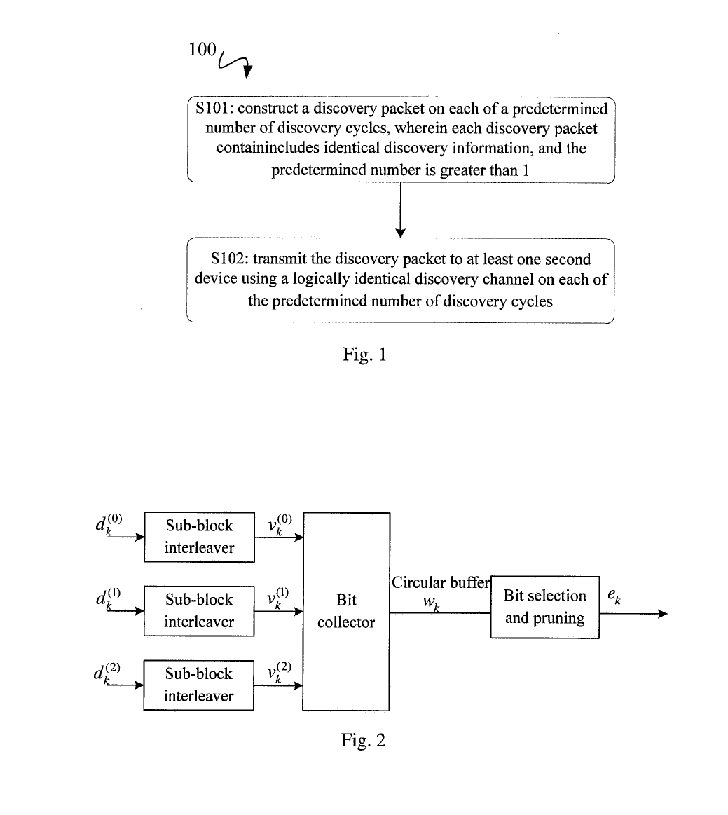

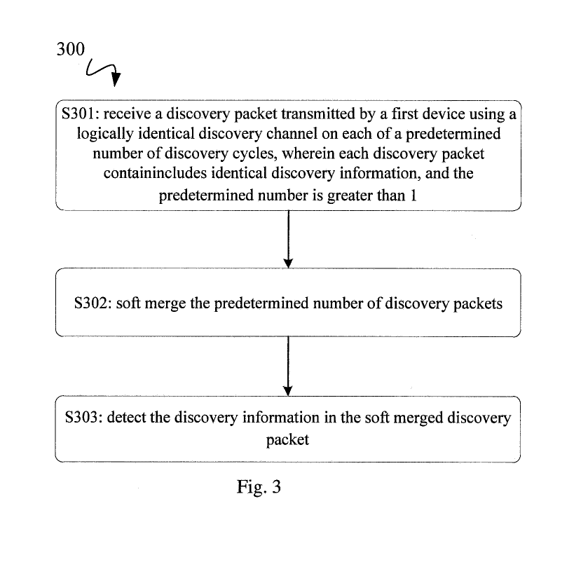

FIG. 1 shows a flow diagram of a method 100 of discovery detection performed by a first device according to an embodiment of the present invention, and FIG. 3 shows a flow diagram of a method 300 of discovery detection performed by a second device according to an embodiment of the present invention. It should be understood that respective steps included in the method 100 and the method 300 may be performed in different sequences, and/or performed in parallel. The method 100 and the method 300 may also comprise additional steps and/or omit in performing some shown steps. The scope of the present invention is not limited in this regard.

At the first device side, after the method 100 starts, at step S101, the first device constructs a discovery packet on each of a predetermined number of discovery cycles.

Herein, each discovery packet includes identical discovery information. The discovery information, such as a device ID and a service ID, and the like, is available for other devices to acknowledge information about the first device, so as to facilitate establishment of D2D communication. In addition, each discovery packet may also include other information, e.g., a preamble and header, and the like.

Herein, the predetermined number is greater than 1. In one implementation, the specific value of the predetermined number may be configured according to the actual conditions by a base station (e.g., eNB) in the communication system. Then, the value of the predetermined number is notified to the first device and the second device. In other implementations, the predetermined number may also be configured by the first device itself or configured through negotiation with the base station, and then the first device or the base station informs the configured predetermined number to the second device. In addition, the predetermined number may also be configured by other devices. Regardless of whether it is configured by the base station, the first device, or other devices, the specific value of the predetermined number may be varied regularly or randomly.

Since the channel resources allocated for transmitting discovery packets are relatively fewer, in order to enhance detection performance of the receiving end regarding the discovery information included in the discovery packets, embodiments of the present invention regard a predetermined number of discovery cycles as a super cycle based on the circular nature of the allocated channel resources, and discovery packets constructed on each discovery cycle within the super cycle include identical discovery information, such that the second device can soft merge the received predetermined number of discovery packets, which thereby achieves power gain, diversity gain, and coding gain and may then enhance detection performance with respect to the discovery information. For a plurality of predetermined numbers of discovery cycles, the discovery packets constructed during the predetermined number of discovery cycles may include identical discovery information or may include different discovery information. Embodiments of the present invention have no limitation in this regard.

According to one embodiment of the present invention, before constructing a discovery packet, the method 100 may also comprise encoding the discovery information into at least one coding version, wherein the number of coding versions of the discovery information may be greater than or equal to the predetermined number, or may be less than the predetermined number.

For different communication systems, the specific manners of encoding the discovery information may be different. For example, the ⅓ rate Turbo code may be used, the specific coding manner of which may be referred to reference literature 1: TS36.212 V11.2.0, Multiplexing and Channel Coding.

By way of example, encoding the discovery information into different coding versions using the ⅓ rate Turbo coding may be implemented according to the flow diagram shown in FIG. 2. In this flow diagram, assume that the discovery information has 104 bits. Turbo coding the discovery information and a 24-bit CRC (circular redundancy check code) results in three bit streams dₖ⁽⁰⁾, dₖ⁽¹⁾, dₖ⁽²⁾, wherein the length of each is 104+24+4=132, including 4 pseudo bits. The dₖ⁽⁰⁾, dₖ⁽¹⁾, dₖ⁽²⁾ go through a sub-block interleaver, resulting in bit streams vₖ⁽⁰⁾, vₖ⁽¹⁾, vₖ⁽²⁾, wherein the length of each is dependent on the amounts of rows and columns of the interleaver. Assume that the amount of rows of each sub-block interleaver is R_{subblock}^{TC}=32 and the amount of columns is C_{subblock}^{TC}=5, then the length of each in vₖ⁽⁰⁾, vₖ⁽¹⁾, vₖ⁽²⁾ is 160. Afterwards, the vₖ⁽⁰⁾, vₖ⁽¹⁾, vₖ⁽²⁾ go through a bit collector, resulting in an overall data block wₖ, which is placed into a circular buffer of the first device. The overall data block wₖ is a combination of vₖ⁽⁰⁾, vₖ⁽¹⁾, vₖ⁽²⁾, with a length of N_{cb}=160*3=480. At this time, a sub-data block matching the length that can be transmitted on the allocated discovery channel in each discovery cycle may be extracted from the overall data block wₖ.

In general, matching the length G that can be transmitted on the allocated discovery channel in each discovery cycle is associated with the channel resources of the discovery channel and the applied data symbols. Suppose G=288. A sub-data block with a length of 288 bits may be extracted from the overall data block wₖ, as a coding version of the discovery information. The starting position k₀ of extracting a sub-data block each time from the overall data block wₖ may be determined by employing the following Equation (1):

$${k}_{0} = {R}_{subblock}^{TC} \cdot ( 2 \cdot ⌈ \frac{{N}_{cb}}{8 {R}_{subblock}^{TC}} ⌉ \cdot mod ( i , M ) + 2 ) \qquad Equation ( 1 )$$

wherein M represents the total number of available coding versions, which, for example, may be 4. i represents a serial number of the current discovery cycle within the predetermined number of discovery cycles, wherein the value of i may be an integer from 0 to N-1; here, N represents the predetermined number. mod(i, M) represents mod operation, i.e., the remainder from i divided by M.

For each coding version, after the starting position k₀ for extraction is determined, a sub-data block with a length of G may be extracted from k₀, so as to define the sub-data block as a coding version of the discovery information, and thereby to construct a discovery packet to be transmitted over the allocated discovery channel. Moreover, it may be seen that k₀ has a unique correspondence relationship with the coding version number of each coding version of the discovery information.

Since the coded bit streams vₖ⁽⁰⁾, vₖ⁽¹⁾, vₖ⁽²⁾ have gone through the interleaver, when extracting the sub-data block with the length of G, NULL symbols may be removed, thereby ensuring that all bits in the extracted sub-data block are valid data information.

It should be noted that what is described above is only exemplarily illustrating use of Turbo coding to encode the discovery information into at least one coding version. Besides, other channel coding approaches may also be employed to encode the discovery information, and the scope of the present invention is not limited in this regard.

According to one embodiment of the present invention, after the discovery information is encoded into at least one coding version, the coding version of the discovery information included in each discovery packet is the same. If the discovery information is encoded into one coding version, this coding version of the discovery information is included in each discovery packet. If the discovery information is encoded into multiple coding versions, one coding version may be selected therefrom, and the selected coding version is included in each discovery packet.

For the sake of redundancy, according to another embodiment of the present invention, the coding versions of the discovery information included in at least two of the predetermined number of discovery packets are different. Herein, in the predetermined number of discovery data packets, if more discover packets include discovery information of different coding versions, coding gain after soft merging the discovery packets by the second device may be enhanced, which will facilitate detection of the discovery information by the second device. According to an alternative embodiment of the present invention, when the number of coding versions of the discovery information is greater than or equal to the predetermined number, the coding versions of the discovery information included in each of the predetermined number of discovery packets is different from one another.

Next, the method 100 proceeds to step S102 of transmitting the discovery packet to at least one second device using a logically identical discovery channel on each of the predetermined number of discovery cycles.

Herein, the discovery channel may be allocated by a base station (e.g., eNB) in a centralized manner, or allocated by the user equipment in a distributed manner. The embodiments of the present invention have no limitation in this regard. Regardless of adopting what manners to allocate the discovery channels, it is only required to ensure that the allocated logical discovery channel number maintains unchanged during the predetermined number of discovery cycles. Here, the identical discovery channels are only identical in logical sense. The physical resources employed by the discovery channels may change regularly or randomly between each discovery cycle in the predetermined number of discovery cycles. The reason is that only by transmitting the discovery packet to at least one second device using a logically identical discovery channel on each of the predetermined number of discovery cycles, can these second devices determine that the predetermined number of discovery packets received on the logically identical discovery channel may be subject to soft merging.

According to an alternative embodiment of the present invention, before transmitting the discovery packet to at least one second device using a logically identical discovery channel on each of the predetermined number of discovery cycles, the discovery packet may also be modulated and pre-coded. For example, the discovery packet is subject to QPSK (Quadrature Phase Shift Keying) and the like and subject to DFT (Discrete Fourier Transformation) precoding, etc. Afterwards, the discovery packet is mapped to the discovery channel in use to be transmitted to at least one second device.

Now, the first device has performed the method 100. Afterwards, it is the second device that continues to perform the method 300 to implement discovery detection. It should be noted that there may be one or more second devices. If there are multiple second devices, each second device may perform the method 300 to implement discovery detection.

At the second device side, after the method 300 starts, at step S301, the second device receives a discovery packet transmitted by a first device using a logically identical discovery channel on each of a predetermined number of discovery cycles, wherein each discovery packet includes identical discovery information, the predetermined number being greater than 1. The second device may pre-negotiate with a base station or the first device that configures the predetermined number about the value of the predetermined number, the discovery channel used by the first device, and other information. For example, the second device may negotiate with the first device through the base station.

Next, the method 300 proceeds to step S302 of soft merging the predetermined number of discovery packets.

In the existing techniques, the first device transmits a discovery packet on each discovery cycle. However, the discovery information included in the discovery packet between each discovery cycle may be changed, such that the second device cannot perform soft merging with respect to the received discovery packets so as to enhance the detection performance. In the embodiments of the present invention, since the discovery information included in each of the predetermined number of discovery packets is the same, the second device may perform soft merging with respect to the predetermined number of discovery packets, so as to enhance the diversity gain and power gain of the soft merged discovery packet, which is advantageous to detect discovery information in the soft merged discovery packet.

According to one embodiment of the present invention, step S302 may also comprise soft merging the predetermined number of discovery packets according to a coding version of the discovery information included in each discovery packet. Herein, if the discovery packet also includes other portions in addition to the discovery information, such as a preamble and header and the like, those portions of information may be removed and only the portion that includes discovery information is soft merged.

According to one embodiment of the present invention, soft merging the predetermined number of discovery packets according to a coding version of the discovery information included in each discovery packet comprises: superimposing soft demodulated outputs corresponding to the predetermined number of discovery packets in a soft bit circular buffer when the coding version of the discovery information included in each discovery packet is the same. The manner of soft demodulation may be configured according to the actual conditions, which may be associated with the modulation manner of the discovery packet by the first device. The superimposing is performed in the soft bit buffer of the second device. Since the coding version of the discovery information included in each discovery packet is the same, the soft bit information outputted from soft demodulating the each received discovery packet may be directly superimposed, which thereby enhances the signal intensity of information bits and improves the power gain of the soft merged discovery packet.

According to another embodiment of the present invention, soft merging the predetermined number of discovery packets according to a coding version of the discovery information included in each discovery packet comprises: superimposing overlapped portions and combining non-overlapped portions between soft demodulated outputs corresponding to the predetermined number of discovery packets according to a coding version number of the discovery information included in each discovery packet in the soft bit circular buffer, when the coding versions of the discovery information included in at least two of the predetermined number of discovery packets are different.

When encoding the discovery information into different coding versions, there may be overlapped portions between discovery information of different coding versions. Based on the coding version number of the discovery information, overlapped portions between soft demodulated outputs corresponding to the discovery packets may be determined. For example, based on k₀ in the above example, the overlapping condition of bits between different coding versions of the discovery information may be found, and then the overlapping condition of the soft demodulated outputs corresponding to the packet including the discovery information may be determined. Regarding the overlapped portions, superimposition may be performed directly to enhance the signal intensity of information bits of the overlapped portions. Meanwhile, the non-overlapped portions may be combined to finally obtain the soft merged discovery packet. Since discovery information of different coding versions is included in the soft merged discovery packet, coding gain of the soft merged discovery packet is enhanced, which is more advantageous to subsequent detection.

Next, the method 300 proceeds to step S303 of detecting the discovery information in the soft merged discovery packet.

Since the gain of the soft merged discovery data has been enhanced in various aspects, e.g., the diversity gain, coding gain, and power gain and the like are enhanced, when detecting the discovery information in the soft merged discovery packet, the detection performance is enhanced and the discovery information can be detected more accurately. If the discovery information is successfully detected in the soft merged discovery packet, the second device may establish D2D communication with the first device.

In addition to enhance detection performance using the above soft merging manner, between a plurality of predetermined numbers of discovery cycles, a manner of hard merging may also be employed to further enhance the detection performance. According to alternative embodiments of the present invention, the first device may also construct discovery packets including identical discovery information between a plurality of predetermined numbers of discovery cycles, and transmit the constructed discovery packets on each discovery cycle among each predetermined number of discovery cycles. At the second device side, when the same discovery information is included in each discovery packet received on each discovery cycle in the plurality of predetermined numbers of discovery cycles, the method further comprises: when the discovery information is detected in any of a plurality of merged discovery packets, determining that the discovery information is successfully detected.

Since the discovery information is repeated on a plurality of predetermined numbers of discovery cycles, for each predetermined number of discovery cycles, a predetermined number of discovery packets may be soft merged, and discovery information may be detected in the soft merged discovery packet. If discovery information is detected once, it is determined that the discovery information is successfully detected. Afterwards, the second device may establish D2D communication with the first device.

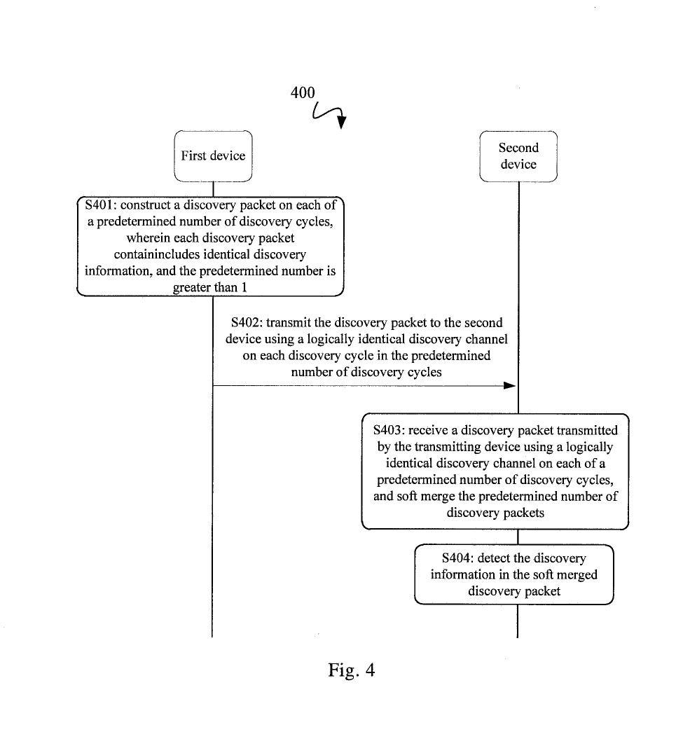

FIGS. 1 and 3 show the detecting methods performed by the first device and the second device, respectively; and FIG. 4 shows an interaction diagram of method 400 of discovery detection performed by the first device and the second device.

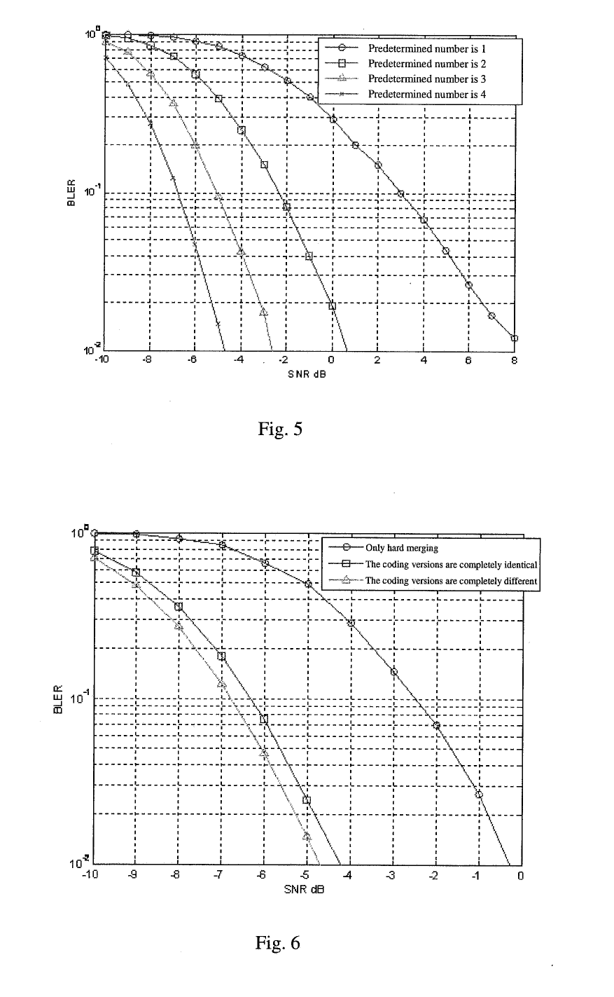

FIGS. 5 and 6 show comparison diagrams of detection performances between employment of an exemplary embodiment of the present invention and a solution in the prior art, wherein BLER (block error rate) and SNR (signal-to-noise ratio) are used to measure the detection performance exemplarily.

Refer to FIG. 5, in which a comparison diagram of detection performances in the case of employing different predetermined numbers is presented. It may be seen from FIG. 5 that when the predetermined number is 1, the detection performance is relatively low. When the predetermined number is greater than 1, the detection performance is significantly enhanced. In addition, with the constant increase of the predetermined number, the detection performance is continuously enhanced.

Refer to FIG. 6, in which a comparison diagram of detection performances in the case of employing different merging manners is presented. When the predetermined number is 4, it is a comparison diagram of detection performances resulting from the following three merging manners: only employing hard merging but without employing soft merging; employing soft merging and the coding version of the discovery information included in each discovery packet being the same; employing soft merging and the coding versions of the discovery information included in a predetermined number of discovery packet are different from one another. It can be seen from FIG. 6 that the second device, which employs soft merging, has a higher detection performance compared to not employing the soft merging. In addition, the larger the number of discovery packets with different coding versions of the included information is, the higher the detection performance is.

The spirit and principle of the present invention has been set forth above with reference to various specific embodiments. Through various embodiments of the present invention, the discovery packets transmitted by the first device using a logically identical discovery channel on each of a predetermined number of discovery cycles include the same discovery information, and the received predetermined number of discovery packets may be soft merged by the second device, which enhances the diversity gain, coding gain, and power gain of the soft merged discovery packet, and then further enhances the detection performance regarding the discovery information in the merged discovery packet.

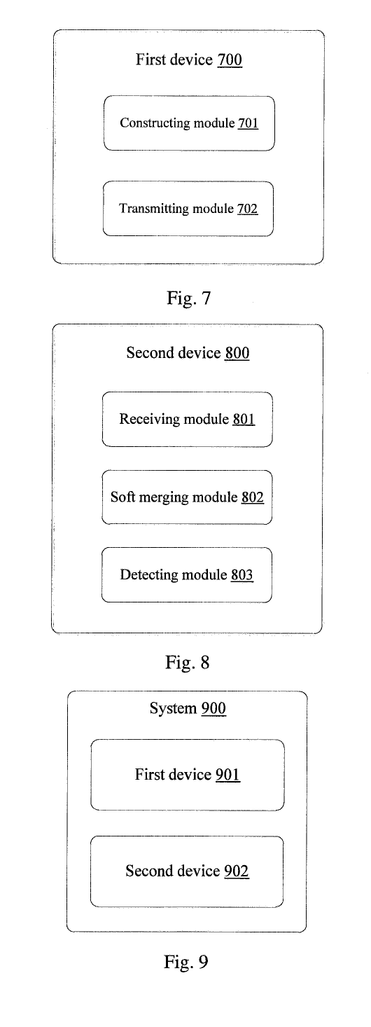

FIG. 7 shows a block diagram of a first device 700 according to an embodiment of the present invention. As shown in the figure, the first device 700 comprises a constructing module 701 for constructing a discovery packet on each of a predetermined number of discovery cycles, wherein each discovery packet includes identical discovery information, the predetermined number being greater than 1; and a transmitting module 702 for transmitting the discovery packet to at least one second device using a logically identical discovery channel on each of the predetermined number of discovery cycles.

The first device 700 further comprises an encoding module for encoding the discovery information into at least one coding version. The coding version of the discovery information included in each discovery packet may be the same. The coding versions of the discovery information included in at least two of the predetermined number of discovery packets may be different.

It may be seen that the first device 700 of FIG. 7 may implement the method shown in FIG. 1. In addition, although not further shown, the first device 700 may comprise more modules or functional units to implement various embodiments described with reference to the method 100 of FIG. 1. Further, the discovery packets transmitted by the first device 700 using the logically identical discovery channels on each discovery cycle in the predetermined number of discovery cycles include identical discover information, such that the second device can soft merge the predetermined number of received discovery packets, which enhances the diversity gain, coding gain, and power gain of the soft merged discovery packet, and then further enhances the detection performance regarding the discovery information in the merged discovery packet.

FIG. 8 shows a block diagram of a second device according to an embodiment of the present invention. As shown in FIG. 8, the second device 800 comprises a receiving module 801 for receiving a discovery packet transmitted by a first device using a logically identical discovery channel on each of a predetermined number of discovery cycles, wherein each discovery packet includes identical discovery information, the predetermined number being greater than 1; a soft combining module 802 for soft merging the predetermined number of discovery packets; and a detecting module 803 for detecting the discovery information in the soft merged discovery packet.

The soft merging module 802 is further for soft merging the predetermined number of discovery packets according to a coding version of the discovery information included in each discovery packet.

The soft merging module 802 is further for superimposing soft demodulated outputs corresponding to the predetermined number of discovery packets in a soft bit circular buffer when the coding version of the discovery information included in each discovery packet is the same.

The soft merging module 802 is further for superimpose overlapped portions and combining non-overlapped portions between soft demodulated outputs corresponding to the predetermined number of discovery packets based on a coding version number of the discovery information included in each discovery packet in the soft bit circular buffer, when the coding versions of the discovery information included in at least two of the predetermined number of discovery packets are different.

When the same discovery information is included in each discovery packet received on each discovery cycle in a plurality of predetermined numbers of discovery cycles, the second device 800 further comprises: a determining module for determining that the discovery information is successfully detected when the discovery information is detected in any of a plurality of merged discovery packets.

It may be seen that the second device 800 of FIG. 8 may implement the method shown in FIG. 1. In addition, although not further shown, the second device 800 may comprise more modules or functional units to implement various embodiments described with reference to the method 300 of FIG. 3. Further, the second device 800 may receive identical discovery information included in the discovery packets transmitted by the first device 700 using a logically identical discovery channel on each of the predetermined number of discovery cycles, and soft merge the predetermined number of received discovery packets, which enhances the diversity gain, coding gain, and power gain of the soft merged discovery packet, and then further enhances the detection performance regarding the discovery information in the merged discovery packet.

FIG. 9 shows a block diagram of a system 900 according to an embodiment of the present invention. As shown in FIG. 9, the system 900 comprises a first device 901 and at least one second device 902, wherein the first device 902 is the first device as shown in FIG. 7, and the second device is the second device as shown in FIG. 8.

In particular, besides hardware embodiments, embodiments of the present invention may also be implemented through a computer program product. For example, the method 100 described with reference to FIG. 1 and the method 300 described with reference to FIG. 3 may be implemented through computer program products. A computer program product may be stored in a storage medium such as RAM, ROM, a flash disk and/or any appropriate storage medium, or downloaded onto a device from an appropriate place in network. The computer program product may comprise a computer code portion including program instructions executed by an appropriate processing device (e.g., CPU).

It should be noted that embodiments of the present invention may be implemented by hardware, software or a combination of the software and hardware. The hardware part may be implemented using a dedicated logic; the software part may be stored in the memory and executed by an appropriate instruction executing system, e.g., a microprocessor or a dedicatedly designed hardware. A normal skilled person in the art may understand that the above device and method may be implemented using a computer-executable instruction and/or being included in processor control codes. Such code is provided on a medium carrier such as magnetic disk, CD or DVD-ROM, a programmable memory such as read-only memory (firmware), or a data carrier such as a optical or electronic signal carrier, for example. The devices and their modules in the present invention may be implemented by a hyper scale integrated circuit or gate array, semiconductor such as logic chips and transistors, or hardware circuitry of programmable hardware devices like field programmable gate arrays and programmable logic devices, or implemented by various kinds of processor-executable software, or implemented by a combination of the above hardware circuits and software, such as firmware.

It should be noted that although several modules or sub-modules of the devices have been mentioned in the above detailed description, such division is merely exemplary but not limiting. In fact, according to embodiments of the present invention, features and functions of two or more modules described above may be embodied in one module. On the contrary, features and functions of one module described above may be embodied by multiple modules.

In addition, although operations of the methods of the present invention are described in a specific order in the accompanying drawings, it is not required or suggested that these operations should be necessarily executed in the specific order or that the desired result can be achieved by executing all illustrated operations. On the contrary, the execution order of steps depicted in the flowcharts may be changed. Additionally or alternatively, some steps may be omitted, a plurality of steps may be combined into one step for execution, and/or one step may be decomposed into a plurality of steps for execution.

Although the present invention has been described with reference to several embodiments, it is to be understood the present invention is not limited to the embodiments disclosed herein. The present invention is intended to encompass various modifications and equivalent arrangements included in the spirit and scope of the appended claims. The scope of the appended claims accords with the broadest interpretation, so as to encompass all of such modifications and equivalent structures and functions.

1. A method for discovery detection in device-to-device communication, comprising:
constructing a discovery packet on each of a predetermined number of discovery cycles, wherein each discovery packet includes identical discovery information, the predetermined number being greater than 1; and
transmitting the discovery packet to at least one second device using a logically identical discovery channel on each of the predetermined number of discovery cycles.

2. The method according to claim 1, further comprising:
encoding the discovery information into at least one coding version.

3. The method according to claim 2, wherein the coding version of the discovery information included in each discovery packet is the same.

4. The method according to claim 2, wherein the coding versions of the discovery information included in at least two of the predetermined number of discovery packets are different.

5. A method for discovery detection in device-to-device communication, comprising:
receiving a discovery packet transmitted by a first device using a logically identical discovery channel on each of a predetermined number of discovery cycles, wherein each discovery packet includes identical discovery information, the predetermined number being greater than 1;
soft merging the predetermined number of discovery packets; and
detecting the discovery information in the soft merged discovery packet.

6. The method according to claim 5, wherein soft merging the predetermined number of discovery packets comprises:
soft merging the predetermined number of discovery packets according to a coding version of the discovery information included in each discovery packet.

7. The method according to claim 6, wherein soft merging the predetermined number of discovery packets according to a coding version of the discovery information included in each discovery packet comprises:
superimposing soft demodulated outputs corresponding to the predetermined number of discovery packets in a soft bit circular buffer when the coding version of the discovery information included in each discovery packet is the same.

8. The method according to claim 6, wherein soft merging the predetermined number of discovery packets according to a coding version of the discovery information included in each discovery packet comprises:
superimposing overlapped portions and combining non-overlapped portions between soft demodulated outputs corresponding to the predetermined number of discovery packets according to a coding version number of the discovery information included in each discovery packet in a soft bit circular buffer, when the coding versions of the discovery information included in at least two of the predetermined number of discovery packets are different.

9. The method according to claim 5, wherein when the same discovery information is included in each discovery packet received on each discovery cycle in a plurality of predetermined numbers of discovery cycles, the method further comprises:
when the discovery information is detected in any of a plurality of merged discovery packets, determining that the discovery information is successfully detected.

10. A device, comprising:
a constructing module for constructing a discovery packet on each of a predetermined number of discovery cycles, wherein each discovery packet includes identical discovery information, the predetermined number being greater than 1; and
a transmitting module for transmitting the discovery packet to at least one second device using a logically identical discovery channel on each of the predetermined number of discovery cycles.

11. The device according to claim 10, further comprising:
an encoding module for encoding the discovery information into at least one coding version wherein the coding version of the discovery information included in each discovery packet is the same or the coding versions of the discovery information included in at least two of the predetermined number of discovery packets are different.

12. (canceled)

13. (canceled)

14. A device, comprising:
a receiving module for receiving a discovery packet transmitted by a first device using a logically identical discovery channel on each of a predetermined number of discovery cycles, wherein each discovery packet includes identical discovery information, the predetermined number being greater than 1;
a soft combining module for soft merging the predetermined number of discovery packets; and
a detecting module for detecting the discovery information in the soft merged discovery packet.

15. The device according to claim 14, wherein the soft merging module is further for soft merging the predetermined number of discovery packets according to a coding version of the discovery information included in each discovery packet wherein the soft merging module is further for superimposing soft demodulated outputs corresponding to the predetermined number of discovery packets in a soft bit circular buffer when the coding version of the discovery information included in each discovery packet is the same and wherein the soft merging module is further for superimposing overlapped portions and combining non-overlapped portions between soft demodulated outputs corresponding to the predetermined number of discovery packets according to a coding version number of the discovery information included in each discovery packet in a soft bit circular buffer, when the coding versions of the discovery information included in at least two of the predetermined number of discovery packets are different.

16. (canceled)

17. (canceled)

18. The device according to claim 14, wherein when the same discovery information is included in each discovery packet received on each discovery cycle in a plurality of predetermined numbers of discovery cycles, the device further comprises:
a determining module for determining that the discovery information is successfully detected when the discovery information is detected in any of a plurality of merged discovery packets.

19. A system, comprising:
a first device according to claim 10; and
at least one second device comprising a receiving module for receiving a discovery packet transmitted by a first device using a logically identical discovery channel on each of a predetermined number of discovery cycles, wherein each discovery packet includes identical discovery information, the predetermined number being greater than
a soft combining module for soft merging the predetermined number of discovery packets; and
a detecting module for detecting the discovery information in the soft merged discovery packet.
